(19) United States
(12) Patent Application Publication
(10) Pub. No.: US 2010/0067123 A1
(43) Pub. Date: Mar. 18, 2010

(54) Imaging device for a bonding apparatus

(75) Inventor: Shigeru Hayata, Musashimurayama-shi (JP)

Correspondence Address: QUINN EMANUEL;KODA & ANDROLIA, 865 S. FIGUEROA STREET, 10TH FLOOR, LOS ANGELES, CA, 90017, US

(73) Assignee: Kabushiki Kaisha Shinkawa

(21) Appl. No.: 12/283,972

(22) Filed: Sep. 17, 2008

(51) Int. Cl. G02B 7/02; G02B 9/00

(52) U.S. Cl. 359/738; 359/819

(57) ABSTRACT

An imaging device for a bonding apparatus including a prism frame, a lens frame and an imaging device frame all made of metallic materials and fixed separately to flat plates made of carbon fiber reinforced plastic so as to be in this order in the optical axis direction of the imaging device. Light shielding plates are fixed to the lens frame to extend toward both ends of the imaging device to form overlapped portions where the thermal expansion is absorbed. The flat plates have a thermal expansion amount of approximately zero to not allow the positions in the optical axis direction of the optical components and the optical characteristics to change even under thermal influence, and thermal expansion is absorbed by the overlapped portions, causing no thermal stress in the imaging device.

### BACKGROUND OF THE INVENTION

The present invention relates to a structure of imaging devices for bonding apparatuses.

Semiconductor manufacturing processes include a die bonding step of bonding semiconductor dies onto circuit substrates and a wire bonding step of wire-connecting electrodes on a semiconductor die, which is bonded on a circuit substrate by die bonding, to electrodes on the circuit substrate. A die bonding apparatus and a wire bonding apparatus that are used for such die bonding and wire bonding steps, and each apparatus is provided with bonding tools such as, respectively, a collet for pressing and bonding a semiconductor die onto a circuit substrate and a capillary for pressing and bonding a connecting wire inserted therethrough to each electrode.

In the case of bonding semiconductor dies by a bonding apparatus and/or wire-connecting electrodes, the coordinates of electrodes on each semiconductor die and on each circuit substrate are required to be input into the bonding apparatus. The electrodes on each semiconductor die or on each circuit substrate are imaged using an imaging device such as a camera and the coordinates of the electrodes are obtained to be input.

For example, Japanese Patent Application Unexamined Publication Disclosure No. 7-297223 discloses a method in which an operator manually operates a manual input means such as a numeric keypad or a chessman to image electrodes on a semiconductor die or on a circuit substrate on a TV monitor, and then aligns each electrode on the circuit substrate with a cross mark drawn at the center of the TV monitor to obtain the coordinates of the electrodes. Japanese Patent Application Unexamined Publication Disclosure No. 10-318711 discloses a method in which electrodes on a semiconductor die or on a circuit substrate are imaged using a CCD (charge-coupled device) camera and the positions of the electrodes are obtained by pattern matching of the images and/or based on the light-dark ratio distributions of the images. Japanese Patent Application Unexamined Publication Disclosure No. 2002-350118 discloses a method in which the displacement of a semiconductor die in its rotation direction is detected using images taken by a camera in a die bonding apparatus and the posture of the semiconductor die is corrected by driving a turntable based on the detection result.

In bonding apparatuses, such an imaging device as mentioned above is adapted to be movable freely in the X and Y directions and is attached to a bonding head that houses a drive motor, etc. for vertically driving a bonding tool, so as to move fast together with the capillary in the X and Y directions (see FIG. 7 of Japanese Patent Application Unexamined Publication Disclosure No. 7-297223, FIG. 1 of Japanese Patent Application Unexamined Publication Disclosure No. 2002-350118, and FIG. 1 of Japanese Patent Application Unexamined Publication Disclosure No. 2000-332050, for example.

Depending on the types of works such as circuit substrates and semiconductor dies, it is also necessary to heat each work during bonding, and therefore a bonding stage, on which each circuit substrate is to be vacuum-sucked and fixed, is provided with a heating means such as an electric heater. This can result in conduction of radiation heat from a circuit substrate that is heated by the heater during bonding to the ultrasonic horn, causing a position variation due to the temperature change of the ultrasonic horn (refer to Japanese Patent Application Unexamined Publication Disclosure No. 2000-332050, for example). For this, Japanese Patent Application Unexamined Publication Disclosure No. 2000-332050 proposes installing a shield plate and an air-cooling nozzle to prevent heat radiation from the heater in a bonding stage.

Japanese Patent Application Unexamined Publication Disclosure No. 2002-202187 proposes a method of reducing the focal shift of an optical sensor mounted on an artificial satellite caused by thermal deformation in orbit and thereby increasing the resolution of the sensor, in which a lens barrel with a lens and a photoelectric converter fixed thereto is made of carbon fiber reinforced plastic, which cannot expand in the optical axis direction and its perpendicular direction.

Like the ultrasonic horn described in Japanese Patent Application Unexamined Publication Disclosure No. 2000-332050, the imaging device is installed over the bonding stage, which can come under the influence of radiation heat from a circuit substrate that is heated by the heater and thereby result in a change in optical characteristics such as field position, focus position, and aberrations caused by thermal expansion to result in an error in coordinates to be detected. As described in Japanese Patent Application Unexamined Publication Disclosure No. Hei 7-297223 or 2002-350118, since the imaging device is attached to a bonding head that houses the drive motor, etc., for vertically driving the leading end of the capillary, thermal expansion due to the heat generation in the motors caused by fast driving can also result in a change in optical characteristics such as field position, focus position, and aberrations to cause an error in coordinates to be detected.

Since the bonding head with an imaging device attached thereto is adapted to move fast in the X and Y directions during bonding and the imaging device is fixed to the bonding head in a cantilevered manner, an inertia force caused by the moment of inertia of the imaging device during fast movement can cause a vibration and the vibration can cause an error in controlling an X-Y table, resulting in a deterioration in bonding quality.

As for the method proposed in Japanese Patent Application Unexamined Publication Disclosure No. 2002-202187 to reduce the change in optical characteristics due to thermal influence, in which the lens barrel is made of specific carbon fiber reinforced plastic which cannot expand in the optical axis direction and its perpendicular direction, there is a problem that carbon fiber reinforced plastic is not easily machinable and a die is required to form carbon fiber reinforced plastic, which makes it difficult to apply carbon fiber reinforced plastic to general machinery components such as imaging device in bonding apparatuses.

In contrast, in a method in which adjusting mechanisms for lenses, etc., are formed by machining metallic materials and combined with carbon fiber reinforced plastic to construct an imaging device, there is a problem that the difference in expansion due to temperature change between carbon fiber reinforced plastic, which have a very small coefficient of thermal expansion, and the common materials such as lightweight alloy can cause a curvature deformation and thereby the optical axis of the optical elements to be misaligned and/or the aberrations to be changed, resulting in a change in the characteristics of the optical elements.

### SUMMARY OF THE INVENTION

It is an object of the present invention to reduce the change in optical characteristics caused by thermal expansion with a simple structure.

The present invention is directed to an imaging device for a bonding apparatus to be installed in a bonding apparatus and having a lens for forming on an image surface of the imaging device an image of an object and an image-pickup device for converting the image formed on the image surface into an electrical signal, and this imaging device includes: a lens frame having the lens mounted thereon; an image-pickup device frame having the image-pickup device mounted thereon; and a base body part having a coefficient of thermal expansion smaller than those of the lens frame and the image-pickup device frame and extending in the optical axis direction of the lens and the image-pickup device to hold the lens frame and the image-pickup device frame.

The imaging device for a bonding apparatus according to the present invention preferably further includes: an optical path changer for changing the optical path from the object and changing the optical path to the lens; and an optical path changer frame fixed to the base body part and having the optical path changer mounted thereon, in which the coefficient of thermal expansion of the base body part is smaller than those of the lens frame, the image-pickup device frame and the optical path changer frame.

The imaging device for a bonding apparatus according to the present invention preferably further includes: a light shielding member fixed to any one of the optical path changer frame, the lens frame, and the image-pickup device frame, the light shielding member being overlapped with the other two frames and extending in the optical axis direction of the optical path changer and the image-pickup device to prevent external light from entering the optical path between the optical path changer and the image-pickup device, and in this imaging device the coefficient of thermal expansion of the base body part is smaller than those of the lens frame, the image-pickup device frame, the optical path changer frame and the light shielding member. Instead, the imaging device can preferably further includes a plurality of light shielding members fixed to the base body part between the optical path changer frame and the lens frame as well as between the lens frame and the image-pickup device frame and overlapped with the frames to prevent external light entering the optical path between the frames, and in this imaging device the coefficient of thermal expansion of the base body part is smaller than those of the lens frame, the image-pickup device frame, the optical path changer frame and the light shielding members.

Alternatively, the imaging device for a bonding apparatus according to the present invention preferably further includes a plurality of lens frames, and a light shielding member fixed to any one of the lens frames and the image-pickup device frame, the light shielding member being overlapped with the other frames and extending in the optical axis direction of the lens and the image-pickup device to prevent external light from entering the optical path between the lens and the image-pickup device, and in this imaging device the coefficient of thermal expansion of the base body part is smaller than those of the lens frames, the image-pickup device frame and the light shielding member.

In the imaging device for a bonding apparatus according to the present invention, the overlapped portions of each frame and each light shielding member are joined by an elastic adhesive. The base body part is composed of two flat plates extending in the optical axis direction to sandwich and hold each frame therebetween. The each light shielding member is provided between the flat plates to prevent external light from entering the optical path between the flat plates. The base body part is made of fiber reinforced plastic in which the number of fibers in the optical axis direction is greater than that in the direction perpendicular to the optical axis.

The present invention exhibits an advantageous effect of reducing the change in optical characteristics caused by thermal expansion with a simple structure.

### BRIEF DESCRIPTION OF THE DRAWINGS

FIG. 1 is an illustrative view showing a structure of a wire bonding apparatus including an imaging device according to an exemplary embodiment of the present invention;

FIG. 2 is a perspective view of the imaging device according to an exemplary embodiment of the present invention;

FIG. 3 is a perspective view showing an internal structure of the imaging device according to an exemplary embodiment of the present invention;

FIG. 4 is a cross-sectional view of the imaging device according to an exemplary embodiment of the present invention;

FIG. 5 is an illustrative view showing an overlapping structure of a light shielding plate and a frame in the imaging device according to an exemplary embodiment of the present invention;

FIG. 6 is a perspective view of an imaging device according to another exemplary embodiment of the present invention;

FIG. 7 is a perspective view showing an internal structure of the imaging device according to another exemplary embodiment of the present invention;

FIG. 8 is a perspective view of an imaging device according to still another exemplary embodiment of the present invention; and

FIG. 9 is a perspective view showing an internal structure of the imaging device according to the still another exemplary embodiment of the present invention.

### DESCRIPTION OF THE EXEMPLARY EMBODIMENTS

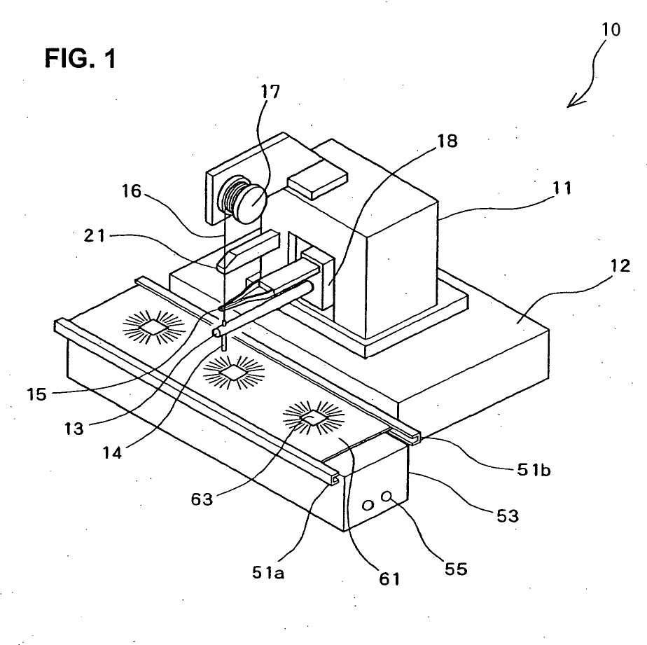

Various exemplary embodiments of the present invention when applied to a wire bonding apparatus will hereinafter be described in detail with reference to the accompanying drawings. As shown in FIG. 1, the wire bonding apparatus 10 includes a Z-direction drive mechanism 18 fitted inside a bonding head 11 that is mounted on an X-Y table 12 so as to be movable freely in the X and Y directions. The Z-direction drive mechanism 18 has an ultrasonic horn 13 and a damper 15 attached thereto, and a capillary 14 is fitted at the leading end of the ultrasonic horn 13. A wire 16 is supplied from a spool 17 and inserted through the capillary 14. An imaging device 21 is fixed to the bonding head 11 in a cantilevered manner. The imaging device 21 houses: a prism as an optical path changer for changing the optical path from an object on a bonding stage 53 and guiding the optical path to a lens which is for forming an image of the object on an image surface; and an image-pickup device for converting the image formed on the image surface into an electrical signal.

The wire bonding apparatus 10 has a frame not shown in the drawing, and the frame is provided with: rails 51a and 51b for guiding a circuit substrate 61 with semiconductor dies 63 mounted thereon; the bonding stage 53 on which the circuit substrate 61 is vacuum-sucked; and a heater 55 for heating the bonding stage 53.

The wire bonding apparatus 10 uses images taken by the imaging device 21 to detect the position of the bonding head 11, moves the X-Y table 12 so that the capillary 14 is aligned with each electrode on each semiconductor die 63, and operates the Z-direction drive mechanism 18 to drive the capillary 14, which is fitted at the leading end of the ultrasonic horn 13, in the Z direction, and then uses the wire 16 inserted through the capillary 14 to bond electrodes on the semiconductor dies 63 with electrodes on the circuit substrate 61. During bonding, the circuit substrate 61 that is vacuum-sucked on the bonding stage 53 is heated by the heater 55 that is arranged in the lower part of the bonding stage 53.

After bonding one electrode on one semiconductor die 63 with one electrode on the circuit substrate 61, the wire bonding apparatus 10 drives the X-Y table 12 to move the capillary 14 over the next electrode and bonds electrodes with the wire 16 in the same way as described above. Then, after bonding all the electrodes on the semiconductor die 63 with electrodes on the circuit substrate 61 using the wire 16, the next die is carried onto the bonding position. This die is imaged by the imaging device 21 and the positions of electrodes are detected based on the image, and thereafter bonding is performed.

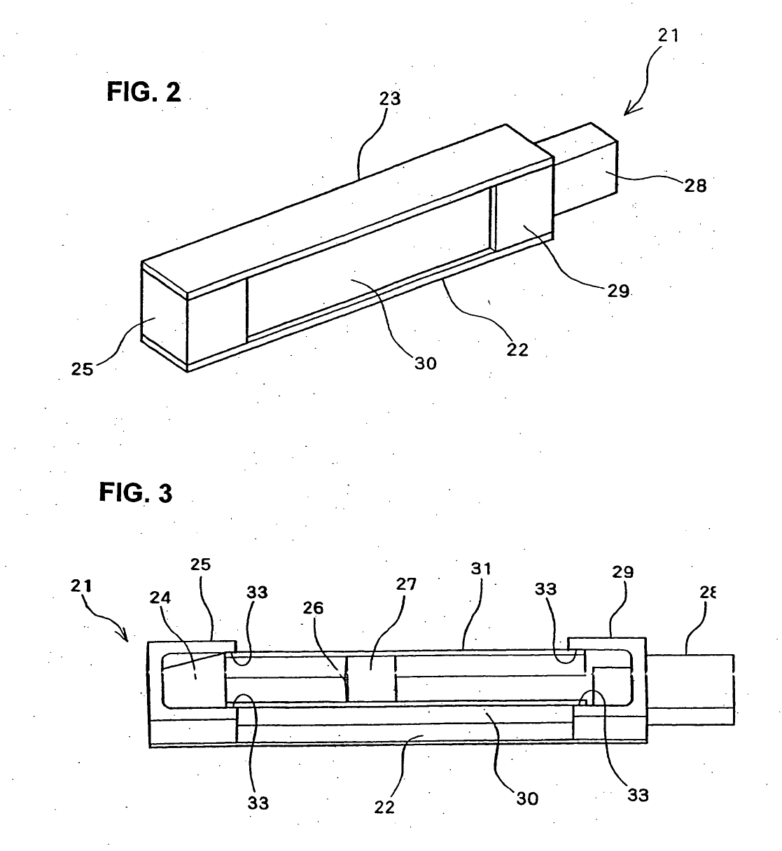

As shown in FIGS. 2 and 3, the imaging device 21 is configured to include: a prism 24, serving as an optical path changer, for changing the optical path from the circuit substrate 61 on the bonding stage 53 and guiding the optical path to a lens 26; the lens 26 for forming an image of an object on an image surface; and an image-pickup device 28 for converting the image formed on the image surface into an electrical signal. The prism 24 is mounted on a prism frame 25, serving as an optical path changer frame, and the lens 26 is mounted on a lens frame 27, and the image pickup device 28 is mounted on an image-pickup device frame 29. The frames 25, 27 and 29 are formed by machining easily machinable metallic materials such as magnesium alloy, aluminum alloy, stainless, and titanium alloy to have a complex shape whereby the optical components mounted thereon can be held and adjusted.

The prism frame 25 has a grooved frame shape so that the triangular prism 24 can be held at faces other than those for the optical path, and the frame 25 is fixed on one end side of a flat plate 22 made of carbon fiber reinforced plastic, serving as a base body part, extending in the optical axis direction. The image-pickup device frame 29 has a grooved frame shape and is fixed on the other end side of the flat plate 22, with the image-pickup device 28 being fixed to the outer surface thereof. The lens frame 27 holds the lens 26 at the periphery thereof and has a hole for the optical path. The lens frame 27 also has a box shape with a width smaller than the inner widths of the prism frame 25 and the image-pickup device frame 29 and is fixed to the flat plate 22 between the prism frame 25 and the image-pickup device frame 29.

Light shielding plates 30 and 31 are fixed on either side of the lens frame 27. The light shielding plates 30 and 31 extend from the lens frame 27 toward the prism frame 25 and the image-pickup device frame 29 and are overlapped with the frames 25 and 29 with a clearance to each inner surface of the frames to form overlapped portions 33. The clearances at the overlapped portions 33 are small enough to prevent direct incidence of external light into the optical path. The light shielding plates 30 and 31 can be made of metal, as is the case with the frames 25, 27 and 29, or can be made of light shielding resin.

Another flat plate 23 made of carbon fiber reinforced plastic as a base body part is mounted on the upper surfaces of the frames 25, 27 and 29. Thus, the frames 25, 27 and 29 are fixed between the two flat plates 22 and 23 with screws or adhesives or both. The frames 25, 27 and 29, flat plates 22 and 23, and light shielding plates 30 and 31 are assembled into a box shape to form a lens barrel that blocks external light from entering the optical path in the imaging device 21. The frames 25,27 and 29 made of metallic materials and the flat plates 22 and 23 made of carbon fiber reinforced plastic can be assembled by securing the frames 25, 27 and 29 using a jig and then installing the flat plates 22 and 23 on either side of the frames.

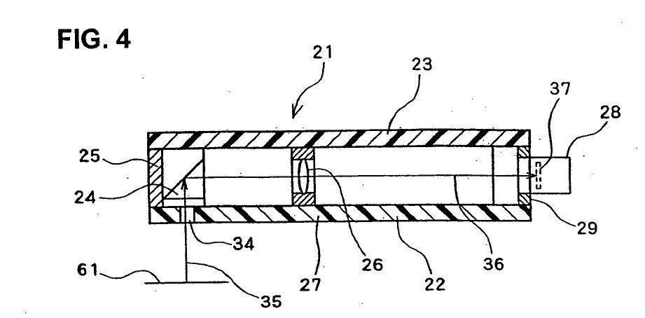

As shown in FIG. 4, light from the circuit substrate 61 as an object travels along the optical path 35 and then passes through the hole 34 of the flat plate 22 to enter the prism 24. The optical path 35 takes a right-angled turn through the prism 24 to travel along the optical axis 36 of the lens 26 and the image-pickup device 28 and is then focused through the lens 26 to be imaged on an image surface 37 of the image-pickup device 28. The image on the image surface 37 is converted into an electrical signal through a CCD or the like provided inside the image-pickup device 28 and then output externally as an image signal. The path from the prism 24 to the image-pickup device 28 is in a lens barrel that blocks the external light, whereby the external light cannot enter the image-pickup device 28.

The carbon fiber reinforced plastic, the constituent material of the flat plates 22 and 23 that are fixed on either side of the frames 25, 27 and 29, is a resin material containing reinforced fibers obtained by texturing carbon fibers in various directions, having anisotropic strength properties depending on the directions of reinforced fibers. In the present exemplary embodiment, the carbon fiber reinforced plastic constituting the flat plates 22 and 23 is arranged in such a manner that the number of reinforced fibers in its longitudinal direction is greater than that in its width direction, whereby the strength in the longitudinal direction is several times larger than those of metallic materials. In addition, the specific gravity is smaller than those of metallic materials such as magnesium alloy, aluminum alloy, stainless, and titanium alloy, whereby the carbon fiber reinforced plastic can achieve lightweight and high stiffness construction. Metallic materials have a coefficient of thermal expansion of about 1×10⁻⁵ to 3×10⁻⁵, while the carbon fiber reinforced plastic can have a coefficient of thermal expansion of approximately zero and thereby is less likely to be affected by thermal expansion.

When bonding is performed using the wire bonding apparatus 10 that includes the thus structured imaging device 21, the circuit substrate 61 on the bonding stage 53 is heated by the heater 55, and the radiation heat caused by the heating produces an increase in temperature of the flat plate 22 that is provided on the bonding stage side of the imaging device 21. The imaging device 21 is also under the thermal influence of the air heated by the heater 55. Further, the imaging device 21, which is fixed to the bonding head 11 on which the Z-direction drive mechanism 18 is mounted, is also under the thermal influence due to the heat generation in the motors of the Z-direction drive mechanism 18. However, the carbon fiber reinforced plastic used has a thermal expansion coefficient of approximately zero and therefore the thermal expansion amount thereof is also approximately zero. The flat plate 23 that is installed on the upper side of the imaging device 21 also has a thermal expansion amount of approximately zero. Meanwhile, the frames 25, 27 and 29 made of metallic materials are heated by radiation heat from the circuit substrate 61 on the bonding stage 53, where since the frames 25, 27 and 29 are fixed separately in line in the optical axis direction between the flat plates 22 and 23, the positions in the optical axis direction of the prism 24, lens 26, and image-pickup device 28 that are fixed to the respective frames 25, 27 and 29 are defined by the flat plates 22 and 23 to which the frames 25, 27 and 29 are fixed. The flat plates 22 and 23 are made of carbon fiber reinforced plastic and thereby have a thermal expansion amount of approximately zero; accordingly, this structure exhibits an effect that the positions in the optical axis direction of the prism 24, lens 26, and image-pickup device 28 and the optical characteristics such as field position, focus position, and aberrations can hardly change even under such thermal influence.

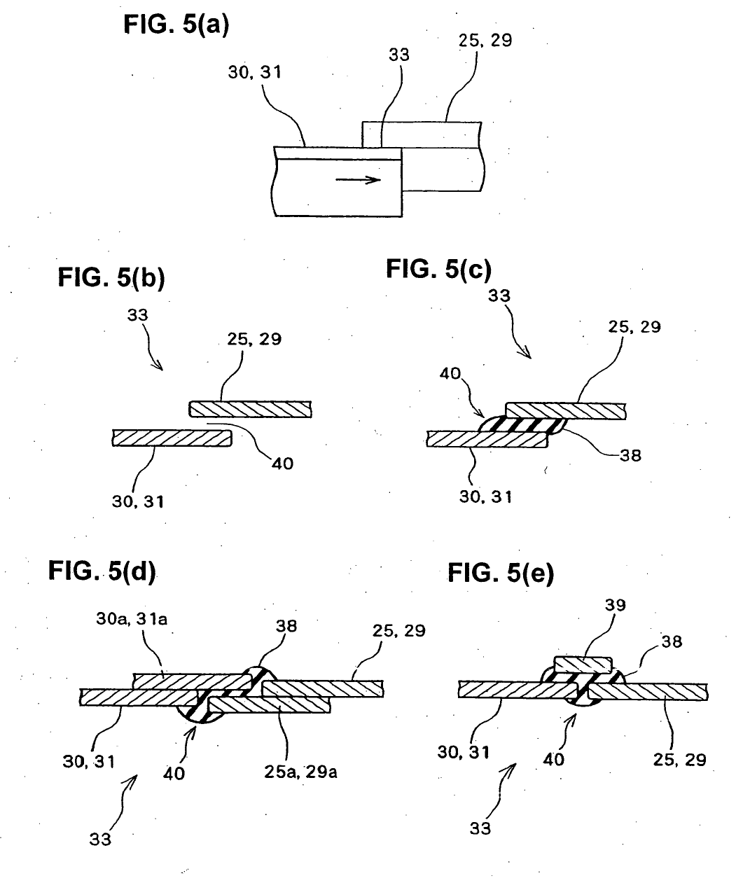

The light shielding plates 30 and 31 for blocking the external light are also under the thermal influence of the air heated by the heater 55 under the circuit substrate 61, and they are further heated also by radiation heat and/or heat transfer from the attaching portions. Since the light shielding plates 30 and 31 are made of metallic or resin materials and extend from the prism frame 25 on one end side of the imaging device 21 to the image-pickup device frame 29 on the other end side, the lengths of the light shielding plates are nearly the same as the entire length of the imaging device 21, causing a difference in thermal expansion with the flat plates 22 and 23, which have a thermal expansion amount of approximately zero. However, the light shielding plates 30 and 31, which are attached to the lens frame 27 that is fixed to approximately the center of the imaging device 21 and not attached to the flat plates 22 and 23, can thermally expand freely with respect to the flat plates 22 and 23. Furthermore, as shown in FIGS. 5(a) and 5(b), the both ends of the light shielding plates 30 and 31 are overlapped slidably with the inner surfaces of the prism frame 25 and the image-pickup device frame 29 to form overlapped portions 33, and a clearance 40 small enough to prevent incidence of the external light is provided at each overlapped portion 33. This arrangement allows the thermal expansion of the light shielding plates 30 and 31 not to be limited, even if the plates 30 and 31 can thermally expand toward the prism frame 25 and the image-pickup device frame 29; as a result, the curvature deformation of the imaging device 21 can be inhibited and therefore the change in optical characteristics can be reduced.

Although the exemplary embodiment of the present invention is described on a structure in which the overlapped portions 33 of the light shielding plates 30 and 31, prism frame 25, and image-pickup device frame 29 are provided with small clearances 40 to absorb the thermal expansion, such clearances 40 cannot necessarily be provided as long as the thermal expansion can be absorbed, and as shown in FIG. 5(c), the overlapped portions 33 of the light shielding plates 30 and 31, prism frame 25, and image-pickup device frame 29 can be filled with an elastic adhesive 38 such as a rubber-based adhesive to absorb the thermal expansion. Also, as shown in FIG. 5(d), the overlapped portions 33 of the light shielding plates 30 and 31, prism frame 25, and image-pickup device frame 29 can be joined by patch plates 30a, 31a, 25a and 29a, and the clearances 40 are filled with the elastic adhesive 38. Alternatively, as shown in FIG. 5(e), the light shielding plates 30 and 31, prism frame 25, and image-pickup device frame 29 can be arranged so that they are not overlapped but have a longitudinal clearance 40 where the thermal expansion can be absorbed, and a patch plate 39 is provided, so that an overlapped portion 33 is formed for light blocking and the clearance 40 is filled with the elastic adhesive 38.

Although the exemplary embodiment of the present invention is described on a structure in which the light shielding plates 30 and 31 are fixed on either side of the lens frame 27, the light shielding plates 30 and 31 can be fixed to any one of the prism frame 25, lens frame 27, and image-pickup device frame 29, while being overlapped with the other frames to form overlapped portions 33. For example, the light shielding plates 30 and 31 can be fixed to the prism frame 25 and to thermally expand toward the image-pickup device frame 29 so that the difference in the thermal expansion between the light shielding plates 30 and 31 and the flat plates 22 and 23 is entirely absorbed at the overlapped portions 33 inside the image-pickup device frame 29. On the contrary, the light shielding plates 30 and 31 can be fixed to the image-pickup device frame 29 so that the difference in the thermal expansion is entirely absorbed at the overlapped portions 33 inside the prism frame 25.

The imaging device 21 is fixed to the bonding head 11 in a cantilevered manner, and during bonding, the motion of the bonding head 11 causes vibrations of the imaging device 21. The vibrations include mainly vertical flexural vibrations, horizontal vibrations, and torsional vibrations. In the exemplary embodiment of the present invention, however, the frames 25, 27 and 29 are fixed between the flat plates 22 and 23 made of carbon fiber reinforced plastic to achieve high stiffness construction; accordingly, this embodiment exhibits an effect of reducing such vibrations. In addition, since the flat plates 22 and 23, serving as base body parts, are made mainly of carbon fiber reinforced plastic, which shows a high vibration damping rate, the entire imaging device 21 can also have a high vibration damping rate, whereby the resonance is less likely to occur and image signals can be output stably. Accordingly, it is possible to prevent reduction in accuracy in detecting positions that is caused by resonance or the like.

In the exemplary embodiment of the present invention, the base body part of the imaging device 21 is formed using the flat plates 22 and 23 made of carbon fiber reinforced plastic; accordingly, the imaging device 21 can be formed and produced efficiently with a simple method of just cutting and installing molded flat plates without using any die.

As described heretofore, the exemplary embodiment of the present invention exhibits an effect of reducing the change in optical characteristics caused by thermal expansion with a simple structure.

Although the exemplary embodiment of the present invention is described on the case that the flat plates 22 and 23 are made of carbon fiber reinforced plastic, the reinforced fiber is not restricted to carbon fibers as long as it is made of fiber reinforced plastic, and other types of reinforced fibers such as glass fibers can be used.

The exemplary embodiment of the present invention is described on the case that the frames 25, 27 and 29 are made of metallic materials, the light shielding plates 30 and 31 are made of metallic or resin materials, and the flat plates 22 and 23 as base body parts are made of carbon fiber reinforced plastic; however, the present invention can also be applied to a case that the flat plates 22 and 23 have a coefficient of thermal expansion smaller than those of the frames and the light shielding plates 30 and 31 in which a simple combination of these components can cause a large thermal stress to occur.

Although the exemplary embodiment of the present invention is described on a structure in which the two upper and lower flat plates 22 and 23 form a base body part and further a box-shaped lens barrel with the light shielding plates 30 and 31, the light shielding plates 30 and 31 cannot be used. In another structure that can be employed, the frames 25, 27 and 29 are fixed on only one base body part made of carbon fiber reinforced plastic or the like, on which a cover-shaped light shielding member fixed to, for example, the lens frame is mounted in such a manner as to cover the entire optical path so that the overlapped portions 33 are provided between the light shielding member and the lens frame 27 as well as the image-pickup device frame 29 to absorb the difference in thermal expansion. Alternatively, light shielding members can be provided separately between the prism frame 25 and the lens frame 27 as well as between the lens frame 27 and the image-pickup device frame 29. All these structures exhibit the same effect as the exemplary embodiment of the present invention.

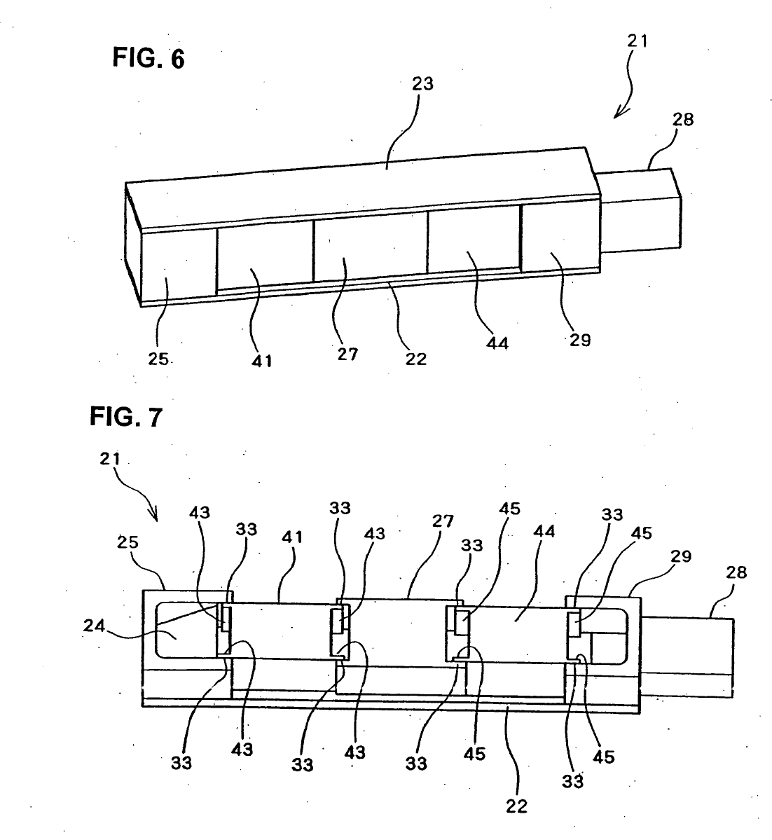

Another exemplary embodiment will be described with reference to FIGS. 6 and 7. Components identical with those in the exemplary embodiment described with reference to FIGS. 1 to 5 will be designated by the same reference numerals to omit descriptions thereof.

As shown in FIGS. 6 and 7, an imaging device 21 according to the exemplary embodiment of the present invention includes two flat plates 22 and 23 as base body parts made of carbon fiber reinforced plastic, prism frame 25, lens frame 27, image-pickup device frame 29, and tubular light shielding members 41 and 44 having a rectangular cross-section. The frames 25, 27 and 29 are fixed separately to and between the flat plates 22 and 23, and the light shielding members 41 and 44 are also fixed separately to and between the flat plates 22 and 23. Light shielding ribs 43 and 45 extend on either side of the light shielding members 41 and 44 along the optical axis so as to be overlapped with the inner surfaces of the frames 25, 27 and 29 to form the overlapped portions 33, whereby the external light can be blocked while the thermal expansion is absorbed. A clearance small enough to prevent incidence of light is provided at each overlapped portion 33. Since the frames 25, 27 and 29 and the light shielding members 41 and 44 are thus separated in the optical axis direction with the overlapped portions 33 and fixed to the flat plates 22 and 23, the difference in thermal expansion among the frames 25, 27 and 29, the light shielding members 41 and 44, and the flat plates 22 and 23 can be absorbed by the overlapped portions 33 even if the imaging device 21 can come under the thermal influence. Accordingly, the present embodiment exhibits an effect that the positions in the optical axis direction of the prism 24, lens 26, and image-pickup device 28 and the optical characteristics such as field position, focus position, and aberrations can hardly change even under such thermal influence, and further such thermal influence does not cause the imaging device 21 to have a curvature deformation and therefore the accuracy in detecting positions to be reduced is obtained.

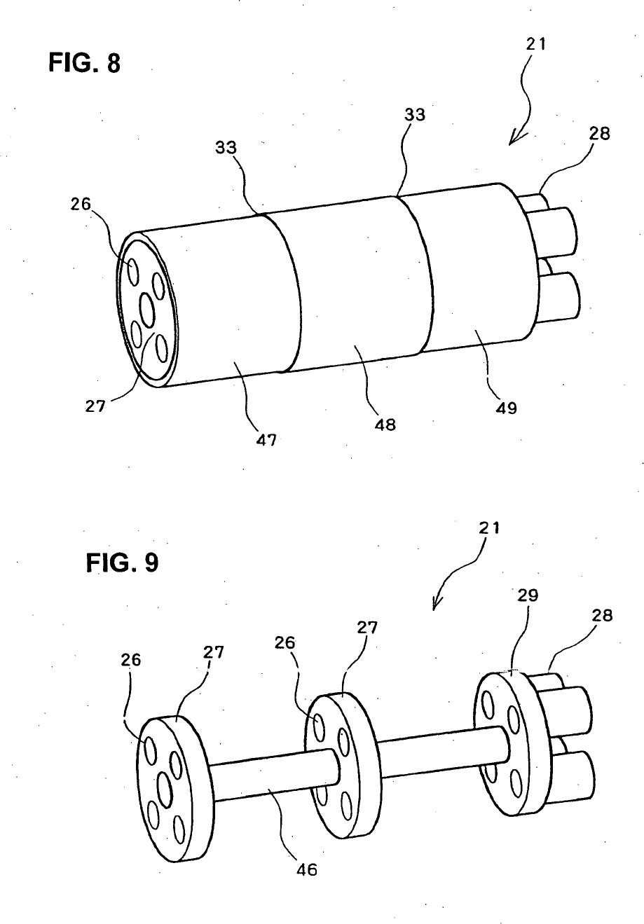

Still another exemplary embodiment of the present invention will be described with reference to FIGS. 8 and 9. In this exemplary embodiment, at the center of a cylindrical imaging device 21 is configured to include: a cylinder 46, serving as a base body part and made of carbon fiber reinforced plastic; two disk-shaped lens frames 27 with four lenses fitted therein; and a cylindrical image-pickup device frame 29 with four image-pickup devices 28 fitted therein, and light shielding covers 47, 48 and 49 are mounted on the outer peripheral surfaces of the frames 27 and 29. Overlapped portions 33 are provided between the covers 47, 48 and 49.

The optical elements are attached to the central cylinder 46 made of carbon fiber reinforced plastic in a secured manner in the optical axis direction; accordingly, the present exemplary embodiment exhibits such an effect that the positions in the optical axis direction of the frames 27 and 29 and the optical characteristics such as field position, focus position, and aberrations can hardly change even under the thermal influence, and further such thermal influence does not cause the imaging device 21 to have a curvature deformation and therefore the accuracy in detecting positions is not reduced.

In addition, since the thermal expansion of the light shielding covers 47, 48 and 49 can be absorbed by the overlapped portions 33 provided therebetween, the thermal influence does not cause the imaging device 21 to have a curvature deformation and therefore the accuracy in detecting positions is not reduced.

Although the above exemplary embodiments are described with reference to the imaging device 21 for wire bonding apparatuses 10, the imaging device 21 according to the present invention can be applied not only to wire bonding apparatuses 10 but also to other types of apparatuses such as die bonding apparatuses.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention from various embodiments and with the various modifications as are suited to the particular use contemplated. It is intended that the scope of the invention be defined by the following claims and their equivalents.

1. An imaging device for a bonding apparatus comprising:
a lens for forming on an image surface of the imaging device an image of an object;
an image-pickup device for converting the image formed on the image surface into an electrical signal;
a lens frame having the lens mounted thereon;
an image-pickup device frame having the image-pickup device mounted thereon; and
a base body part having a coefficient of thermal expansion smaller than those of the lens frame and the image-pickup device frame and extending in an optical axis direction of the lens and the image-pickup device to hold the lens frame and the image-pickup device frame.

2. The imaging device for a bonding apparatus according to claim 1, further comprising:
an optical path changer for changing an optical path from the object and guiding the optical path to the lens; and
an optical path changer frame fixed to the base body part and having the optical path changer mounted thereon, wherein
a coefficient of thermal expansion of the base body part is smaller than those of the lens frame, the image-pickup device frame and the optical path changer frame.

3. The imaging device for a bonding apparatus according to claim 2, further comprising:
a light shielding member fixed to any one of the optical path changer frame, the lens frame, and the image-pickup device frame, the light shielding member being overlapped with the other two frames and extending in the optical axis direction of the optical path changer and the image-pickup device to prevent external light from entering the optical path between the optical path changer and the image-pickup device, wherein
the coefficient of thermal expansion of the base body part is smaller than those of the lens frame, the image-pickup device frame, the optical path changer frame and the light shielding member.

4. The imaging device for a bonding apparatus according to claim 2, further comprising:
a plurality of light shielding members fixed to the base body part between the optical path changer frame and the lens frame as well as between the lens frame and the image-pickup device frame and overlapped with the frames to prevent external light from entering the optical path between the frames, wherein
the coefficient of thermal expansion of the base body part is smaller than those of the lens frame, the image-pickup device frame, the optical path changer frame and the light shielding members.

5. The imaging device for a bonding apparatus according to claim 1, further comprising:
a plurality of lens frames;
a light shielding member fixed to any one of the lens frames and the image-pickup device frame, the light shielding member being overlapped with the other frames and extending in the optical axis direction of the lens and the image-pickup device to prevent external light from entering the optical path between the lens and the image-pickup device, wherein
the coefficient of thermal expansion of the base body part is smaller than that of each one of the plurality of lens frames, the image-pickup device frame and the light shielding member.

6. The imaging device for a bonding apparatus according to claim 3, wherein
the overlapped portions of each frame and each light shielding member are joined by an elastic adhesive.

7. The imaging device for a bonding apparatus according to claim 4, wherein
the base body part is composed of two flat plates extending in the optical axis direction to sandwich and hold each frame therebetween the overlapped portions of each frame and each light shielding member are joined by an elastic adhesive.

8. The imaging device for a bonding apparatus according to claim 5, wherein
the each light shielding member is provided between the flat plates to prevent external light from entering the optical path between the flat plates the overlapped portions of each frame and each light shielding member are joined by an elastic adhesive.

9. The imaging device for a bonding apparatus according to any of claims 1 to 8 claim 1, wherein
the base body part is made of fiber reinforced plastic in which fibers in the optical axis direction is greater in number than in a direction perpendicular to the optical axis the base body part is composed of two flat plates extending in the optical axis direction to sandwich and hold each frame therebetween.

10. The imaging device for a bonding apparatus according to claim 2, wherein the base body part is composed of two flat plates extending in the optical axis direction to sandwich and hold each frame therebetween.

11. The imaging device for a bonding apparatus according to claim 3, wherein the base body part is composed of two flat plates extending in the optical axis direction to sandwich and hold each frame therebetween.

12. The imaging device for a bonding apparatus according to claim 4, wherein the base body part is composed of two flat plates extending in the optical axis direction to sandwich and hold each frame therebetween.

13. The imaging device for a bonding apparatus according to claim 5, wherein
the base body part is composed of two flat plates extending in the optical axis direction to sandwich and hold each frame therebetween.

14. The imaging device for a bonding apparatus according to claim 9, wherein
the each light shielding member is provided between the flat plates to prevent external light from entering the optical path between the flat plates.

15. The imaging device for a bonding apparatus according to claim 10, wherein
the each light shielding member is provided between the flat plates to prevent external light from entering the optical path between the flat plates.

16. The imaging device for a bonding apparatus according to claim 11 wherein
the each light shielding member is provided between the flat plates to prevent external light from entering the optical path between the flat plates.

17. The imaging device for a bonding apparatus according to claim 12, wherein
the each light shielding member is provided between the flat plates to prevent external light from entering the optical path between the flat plates.

18. The imaging device for a bonding apparatus according to claim 13, wherein
the each light shielding member is provided between the flat plates to prevent external light from entering the optical path between the flat plates.

19. The imaging device for a bonding apparatus according claim 1, wherein
the base body part is made of fiber reinforced plastic in which fibers in the optical axis direction is greater in number than in a direction perpendicular to the optical axis.

20. The imaging device for a bonding apparatus according claim 2, wherein
the base body part is made of fiber reinforced plastic in which fibers in the optical axis direction is greater in number than in a direction perpendicular to the optical axis.

21. The imaging device for a bonding apparatus according claim 3, wherein
the base body part is made of fiber reinforced plastic in which fibers in the optical axis direction is greater in number than in a direction perpendicular to the optical axis.

22. The imaging device for a bonding apparatus according claim 4, wherein
the base body part is made of fiber reinforced plastic in which fibers in the optical axis direction is greater in number than in a direction perpendicular to the optical axis.

23. The imaging device for a bonding apparatus according claim 5, wherein
the base body part is made of fiber reinforced plastic in which fibers in the optical axis direction is greater in number than in a direction perpendicular to the optical axis.
